(19) United States
(12) Patent Application Publication
(10) Pub. No.: US 2025/0153080 A1
(43) Pub. Date: May 15, 2025

(54) APPARATUS AND METHOD FOR DEHUMIDIFYING GASES AND A SYSTEM WITH SUCH A DEVICE AND METHOD

(71) Applicant: MAFAC – E. Schwarz GmbH & Co. KG, Alpirsbach (DE)

(72) Inventors: Joachim Schwarz, Freudenstadt (DE); Jonas Danner, Dornhan (DE); Stefan Schaal, Dornstetten (DE)

(73) Assignee: MAFAC – E. Schwarz GmbH & Co. KG, Alpirsbach (DE)

(21) Appl. No.: 18/941,050

(22) Filed: Nov. 8, 2024

(30) Foreign Application Priority Data
Nov. 13, 2023 (DE) 102023131483.1

(51) Int. Cl. B01D 45/16; B01D 53/26

(52) U.S. Cl. CPC B01D 45/16; B01D 53/265; B01D 2257/80; B01D 2258/06

(57) ABSTRACT

A device for dehumidifying gases includes a treatment container having an upper end, a lower end, and an inlet disposed on a side of the treatment container. A plurality of concentric channels is disposed inside the treatment container, where each of the channels is in communication with the inlet and opens toward the lower end of the treatment container. The device also includes an outlet pipe around which the plurality of concentric channels is disposed. The outlet pipe has an inlet at a lower end of the concentric channels and extends out of the treatment container at the upper end. The concentric channels may be formed by a sidewall of the treatment container, the outlet pipe, and a plurality of cylindrical members spaced apart from each other between the sidewall and the outlet pipe. A coolant pipe may be disposed on at least one of the cylindrical members.

### CROSS-REFERENCE TO RELATED APPLICATION

This application claims priority to German Patent Application No. DE 10 2023 131 483.1, filed on Nov. 13, 2024, which is incorporated by reference herein.

### TECHNICAL FIELD

This disclosure relates to a dehumidifying apparatus for dehumidifying gases, such as air.

### BACKGROUND

In various industrial processes, such as in the industrial cleaning of parts, for example, moist and—depending on the process—also contaminated gases are produced.

Centrifugal separators, so-called cyclones, can be used for cleaning contaminated gases. DE 2 058 674 describes such a cyclone for dedusting gases. The cyclone includes a container which tapers conically downwards, a gas inlet arranged on a side of the container, a gas outlet arranged at the top of the container, and a particle outlet arranged at a lower end of the container.

DE 1 782 142 describes a cyclone for separating particles from gases. The cyclone includes a container, an inflow pipe for a contaminated gas projecting into the container from below, a plurality of inlets arranged at various lateral positions of the container for supplying a gaseous medium, and a gas outlet arranged at the top of the container.

DE 1 769 240 describes a centrifugal separator for separating liquid and gas.

### SUMMARY OF THE INVENTION

It is desirable to provide an efficient dehumidifying apparatus, in particular a dehumidifying apparatus based on a centrifugal separator (cyclone).

One example relates to an apparatus. The apparatus includes a treatment container having an upper end, a lower end, and an inlet disposed on a side of the treatment container, and a plurality of concentric channels disposed inside the treatment container, each in communication with the inlet, and opening toward the lower end of the treatment container. The apparatus further includes an outlet pipe around which the plurality of concentric channels are disposed, the outlet pipe having an inlet at a lower end of the concentric channels, and extending out of the treatment tank at the upper end.

### BRIEF DESCRIPTION OF DRAWINGS

Examples are explained below with reference to drawings. The drawings serve to illustrate certain principles, so that only aspects necessary for understanding these principles are illustrated.

FIG. 1 shows a side view of an apparatus for processing, in particular for dehumidifying and cleaning gases;

FIG. 2 shows a horizontal sectional view of the apparatus shown in FIG. 1 in a sectional plane A-A;

FIGS. 3A and 3B show a perspective sectional view of the apparatus;

FIGS. 4A-4D show an example of a fresh air supply of the apparatus;

FIG. 5 shows an example of a fixed cover of the apparatus;

FIG. 6 shows a perspective view of a condensation arrangement disposed inside the apparatus according to an example;

FIG. 7 shows a perspective view of a condensation arrangement disposed inside the apparatus according to a further example, wherein the condensation arrangement includes one or more coolant pipes;

FIG. 8 schematically shows an example of a system with an apparatus for processing gases and a treatment apparatus for workpieces;

FIG. 9 shows a modification of the system according to FIG. 8;

FIG. 10 shows a modification of the system according to FIG. 9; and

FIGS. 11A-11B show an example of the treatment apparatus.

### DETAILED DESCRIPTION OF VARIOUS EMBODIMENTS

The drawings are not to scale. In the drawings, the same reference numerals designate the same features. Of course, the features of the various exemplary embodiments described herein can be combined with one another, unless explicitly stated otherwise.

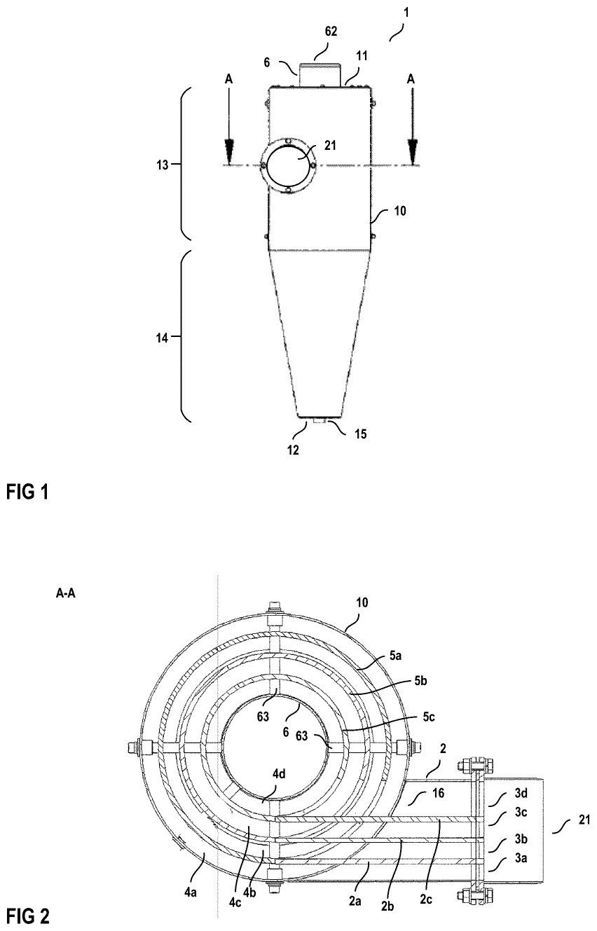

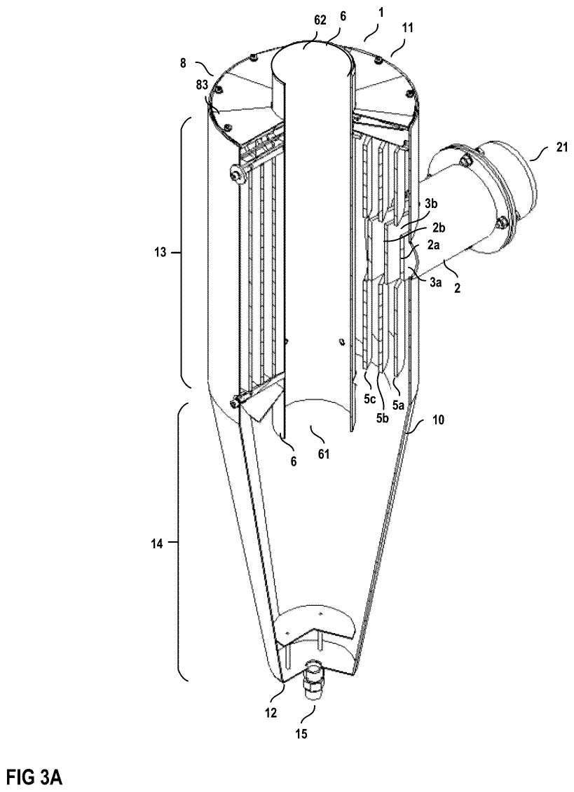

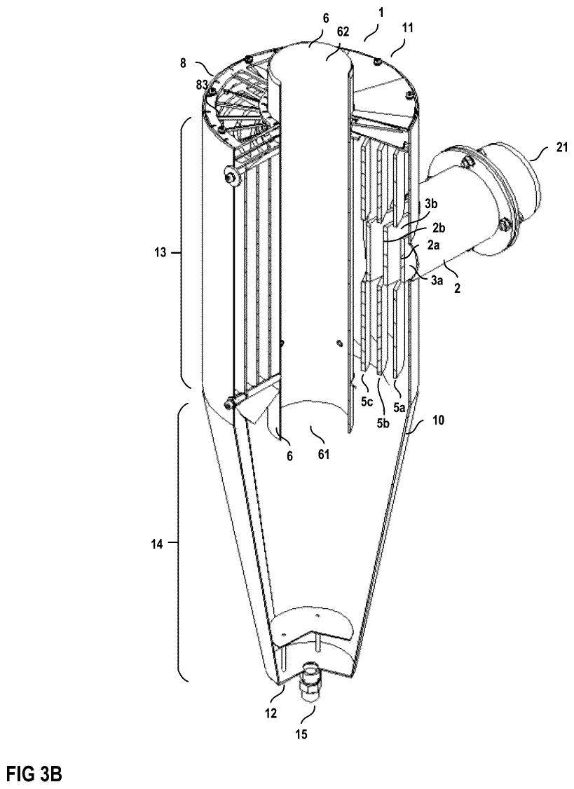

FIG. 1 shows a side view of an apparatus for processing gases, in particular for dehumidifying and cleaning gases, according to an example. This apparatus is hereinafter be briefly referred to as a dehumidifying apparatus, even though a function of the apparatus is not limited to dehumidifying gases, but can also include a cleaning of the respective gas, in particular a removal of dirt particles. FIG. 2 shows a sectional view of the dehumidifying apparatus according to FIG. 1 in a sectional plane A-A shown in FIG. 1. FIGS. 3A-3B show a perspective sectional view of the dehumidifying apparatus 1 according to various embodiments.

Referring to FIGS. 1-2 and 3A-3B, the dehumidifying apparatus 1 includes a rotationally symmetrical treatment container 10 having an upper end 11, a lower end 12, and an inlet 21, also referred to as feed opening in the following, disposed on a side of the treatment tank 10. The terms “upper end 11” and “lower end 12” refer to the fact that, during operation of the apparatus, the treatment container 10 is oriented such that the treatment container 10 stands upright (as shown in FIG. 1) such that the upper end 11 is located above the lower end 12 in a vertical direction.

Referring to FIG. 2, the dehumidifying apparatus further includes a plurality of concentric channels 4a, 4b, 4c, 4d disposed inside the treatment container 10. The concentric channels 4a-4d are each in communication with the inlet 21, and (as shown in FIG. 3) opening toward the lower end 12 of the treatment container 10. The fact that the concentric channels 4a-4d are in communication with the inlet 21 means that a gas flow introduced into the treatment container 10 via the inlet 21 enters the individual concentric channels 4a-4d, wherein the gas flow splits in such a way that a partial flow of the gas flow introduced via the inlet 21 flows in the individual concentric channels 4a-4d. In the examples shown in FIGS. 2 and 3, the apparatus includes four concentric channels 4a-4d. However, this is only one example. According to one example, between 2 and 20, in particular between 4 and 15 concentric channels 4a-4d are provided.

Referring to FIGS. 1-2 and 3A-3B, the dehumidifying apparatus 1 further includes an outlet pipe 6 around which the plurality of concentric channels 4a-4d are disposed. The outlet pipe 6 includes an inlet 61 at a lower end of the concentric channels 4a-4d and extends out of the treatment container 10 at the upper end 11. The outlet pipe 6 and the cylindrical members 5a-5c can be fixed to the sidewall of the treatment container 10, for example, using webs 63 (cf. FIG. 2).

At the lower end 12, the treatment container 10 has a liquid outlet, for example.

As shown in FIG. 2, the supply opening 21 of the dehumidifying apparatus 1 can be formed by an inlet pipe 2 that opens into the treatment container 10 on a side thereof. A plurality of channels 3a-3d can be formed in the inlet pipe 2, where each of the channels 3a-3d opens into a respective one of the concentric channels 4a-4d inside the treatment container 10. The channels 3a-3d, hereinafter also referred to as elongated channels 3a-3d, are formed, for example, by one or more sidewalls of the inlet pipe 2 and by webs 2a-2c disposed inside the inlet pipe 2. As shown in FIGS. 1 and 3, the inlet pipe 2 can be a cylindrical inlet pipe. However, this is only one example. The inlet pipe 2 could also have a rectangular or any other cross-section.

According to one example, the inlet pipe 2 is disposed on the treatment container 10 such that the elongated channels 3a-3d open tangentially into the concentric channels 4a-4d inside the treatment container 10, so that a gas flowing in via the channels can continue to flow in the concentric channels 4a-4d with as little resistance as possible.

As shown in FIG. 2, the concentric channels 4a-4d inside the treatment container 10 can be formed by a sidewall of the treatment container 10, the outlet pipe 6 spaced apart from the sidewall, and a plurality of concentric cylindrical members 5a-5c disposed between the sidewall of the treatment container 10 and the outlet pipe 6. The concentric members 5a-5c will hereinafter also be referred to as cylindrical lamellae (or fins) or cylindrical guide plates. The treatment container 10, the outlet pipe 6, and the cylindrical members 5a-5c are each made of a metal, for example. The treatment container 10 and the outlet pipe 6 are made of stainless steel, for example. The cylindrical members 5a-5c are made of a highly thermally conductive material, such as aluminum, copper, or stainless steel, for example.

As shown in FIG. 1 or 3A and 3B, the treatment container 10 can include a cylindrical upper portion 13 and a lower portion 14 tapering conically towards the lower end 12. The upper portion 13 is disposed between the upper end 11 and the lower portion 14. The concentric channels 4a-4d, and thus the cylindrical members 5a-5c, are disposed in the upper cylindrical portion 13 of the treatment container 10. The outlet pipe 6 extends towards the lower end 12 at least to the level of lower ends of the members 5a-5c, but can also extend further than the lower ends of the members 5a-5c towards the lower end 12 of the treatment container 10. That is, the inlet 61 of the outlet pipe 6 can be located at the level of the lower ends of the cylindrical members 5a-5c in the vertical direction or can be spaced apart from the lower ends of the cylindrical members 5a-5c towards the lower end 12 of the treatment container 10. The “lower ends of the cylindrical members 5a-5c” are the ends of the cylindrical members 5a-5c disposed towards the lower end 12 of the treatment container 10.

“Upper ends of the cylindrical members 5a-5c” are those ends disposed towards the upper end 11 of the treatment container 10. According to an example, the supply pipe 21 is spaced apart from the upper ends in the vertical direction and spaced apart from the lower ends of the cylindrical members 5a-5c. The inlet pipe 2 is disposed, for example, approximately in the upper third of the upper portion 13 of the treatment container 10. A distance of the inlet pipe 2 from the upper end is thus, for example, between 0.2 times and 0.6 times the distance of the inlet pipe 2 from the lower end of the cylindrical members 5a-5c.

The height of the upper portion 13, which is the dimension of the upper portion 13 in the vertical direction, is, for example, between 30 centimeters (cm) and 100 cm, in particular between 40 cm and 80 cm. A height of the lower portion 14, which is the dimension of the lower portion 14 in the vertical direction, is, for example, in the same range as the height of the upper portion 13. According to an example, a ratio between a height of the upper portion 13 and a height of the lower portion 14 is between 2:1 and 1:2.

A diameter of the treatment container 10 in the upper portion 13 is, for example, between 20 cm and 40 cm, in particular between 25 cm and 35 cm. A diameter of the outlet pipe 6 is, for example, between 5 cm and 15 cm.

The mode of operation of the dehumidifying apparatus 1 according to FIGS. 1-2 and 3A-3B is briefly explained below. As already explained, the feed opening 21 serves to feed a gas to be dehumidified and optionally to be purified to the dehumidifying apparatus 1. The dehumidified and optionally purified gas is discharged from the dehumidifying apparatus 1 via the outlet opening 62 of the outlet pipe 6. For supplying the gas to be dehumidified, the dehumidifying apparatus 1 can be connected to a pipe system via which the gas to be dehumidified enters the inlet 21 of the dehumidifying apparatus 11. For discharging the dehumidified gas, a corresponding pipe system can be connected to the outlet 62 of the outlet pipe 6. The gas to be dehumidified is air, for example. In this case, the pipe system at the outlet 62 could also be omitted and the dehumidified air could be discharged into the environment of the dehumidifying apparatus 1.

In order to ensure a sufficient flow rate of the gas within the dehumidifying apparatus 1, at least one turbomachine, such as a fan, a blower or a pump, for example, can be provided. According to an example, a turbomachine (not shown) is arranged at the outlet 62 of the dehumidifying apparatus 1, where the turbomachine sucks the dehumidified gas out of the dehumidifying apparatus 1 and at the same time sucks gas to be dehumidified into the dehumidifying apparatus 1 via the supply opening 21. If the gas to be dehumidified is air which is to be discharged to the environment after dehumidifying, the discharge of the dehumidified air to the environment can take place at the outlet of the turbomachine.

The gas flowing in is forced into a circulation movement by the concentric channels 4a-4d, wherein the moist gas flow in the individual channels 4a-4d moves spirally downwards into the lower portion 14 of the treatment container 10. A centrifugal force associated with the circulation movement of the gas causes the gas to be pressed against the cylindrical members 5a-5c and to condense there.

The circulation movement of the gas can also continue in the lower portion 14 of the treatment container 10, where the downward movement of the circulating gas in the lower portion 14 slows down and the gas flow then continues centrally in the lower portion 14 upwards towards the outlet pipe 6. The circulation movement of the gas can be maintained so that the circulation movement of the gas is also still present in the outlet pipe 6. Moisture droplets, which form due to the condensation at the cylindrical members 5a-5c and the sidewall of the treatment container 10, agglomerate and flow/drop downwards, where the collecting liquid can be discharged via the outlet 15. The moisture droplets falling downwards in the lower portion 14 of the dehumidifying apparatus 1 act as condensation nuclei and can thus also contribute to further dehumidification for gas already present in the lower portion 14.

Due to the explained centrifugal forces, particles, which may be contained as impurities in the gas, are also pressed against the members 5a-5c or the tank wall in the upper portion 13 of the treatment container and against the tank wall in the lower portion 14 of the treatment container, from where the particles sink downwards and can be discharged via the outlet 15 together with the liquid collecting in the lower region.

Due to the cylindrical members 5a-5c, which split the gas flow into several partial flows, the dehumidifying apparatus 1 has a large condensation surface, whereby dehumidification of the gas flowing in is ensured in an efficient manner. The condensation effect of the condensation arrangement formed by the cylindrical members 5a-5c is all the better, the better the members (lamellae, fins) are cooled.

The temperature of the gas to be dehumidified is, for example, between 30° C. and 90° C. There are various possibilities for cooling the members 5a-5c.

According to a first possibility, the above-explained dehumidifying method is carried out intermittently. That is, a gas to be dehumidified is supplied to the dehumidifying apparatus 1 for a certain time in order to dehumidify the gas. Thereafter, a cool gas, such as cool air, is guided for a certain period of time via the supply opening 21 through the dehumidifying apparatus 1 in order to cool the members 5a-5c and also to achieve a good condensation result for the next dehumidifying process. For this method, the treatment container 10 can be closed at the upper end 11 around the outlet pipe 6 in a fixed manner, i.e., in an airtight manner. The temperature of the supplied cool gas is, for example, between 15° C. and 25° C.

Another possibility for cooling the members 5a-5c is to provide a fresh air supply device 8 at the upper end 11 of the treatment container 10. Such a fresh air supply device, which is briefly referred to as fresh air supply 8 is shown in FIGS. 3A and 3B.

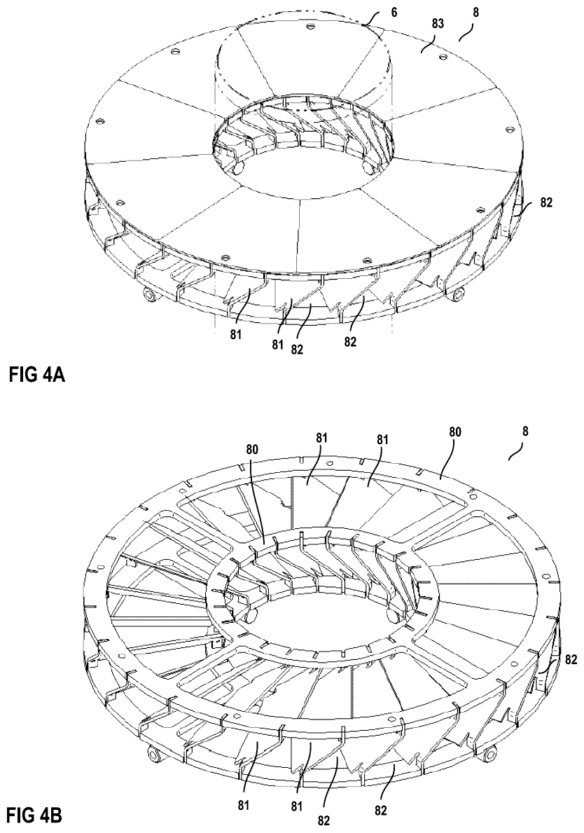

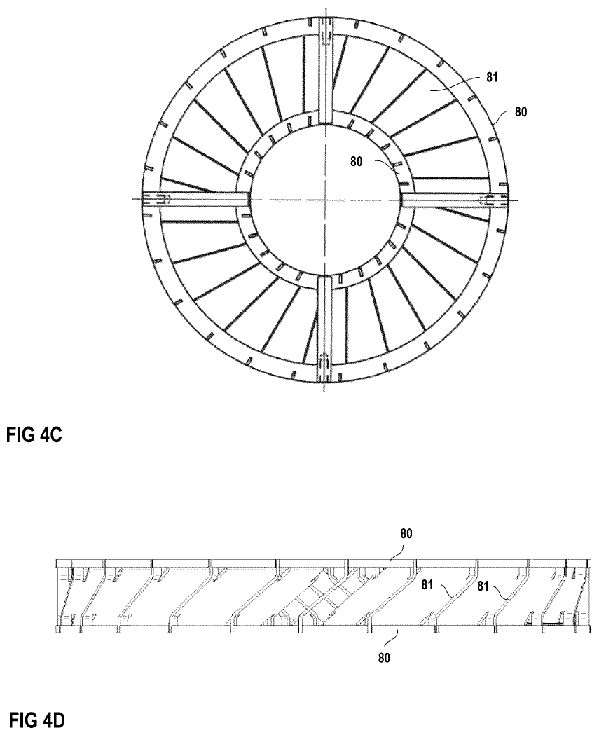

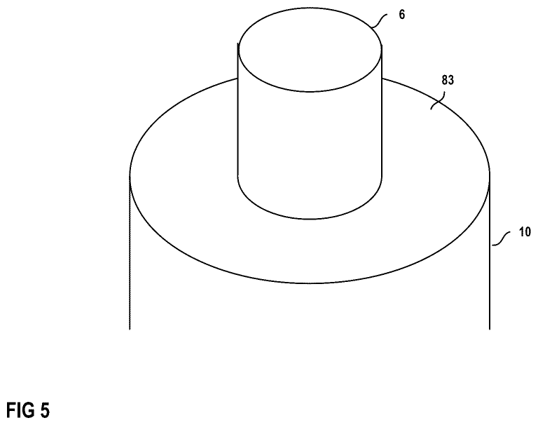

A fresh air supply according to FIGS. 3A and 3B is shown in detail in FIGS. 4A-4D. FIG. 4A shows a perspective view of the fresh air supply 8; FIG. 4B shows a further perspective view of the fresh air supply 8, where a cover 83 shown in FIG. 4A is not shown in FIG. 4B; FIG. 4C shows a view from below of the fresh air supply 8, where the cover 83 is also not shown in FIG. 4C; and FIG. 4D shows a side view of the fresh air supply 8.

As shown in FIGS. 4A-4D, the fresh air supply (fresh air intake) 8 includes guide vanes 81 supported by a frame 80 and extending radially outwards from the outlet pipe 6 (shown in dashed lines in FIG. 4A). Air supply channels 82 are formed between the guide vanes 81 and are open downwards, i.e. towards the inside of the treatment container 10. Upwards (in an upward direction), the air supply channels 82 may be completely open, partially open or completely closed depending on the intended use. Fresh air inlets formed at an upper end of the air supply channels 82 are directed vertically upwards, i.e. in the vertical direction of the treatment container 10. The cover 83 includes a plurality of annular segments for this purpose. The air supply channels 82 are completely open when all segments of the cover 83 are omitted, partially open or partially covered when only some of the segments are present and others are omitted, and completely closed when all segments of the cover 83 are present. The air supply channels 82 are directed upwards and, when open, allow a flow of fresh air vertically from above through the air supply channels 82 down into the treatment container 10, whereby the incoming air is deflected in the air supply channels 82 and thus acquires a radial flow component in addition to a vertical flow component.

Completely closed air supply channels 82 are shown by way of example in FIG. 3A. In this case, the segments form a closed cover which covers all air supply channels 82. An example in which the air supply channels 82 are partially covered is shown in FIG. 3B. FIG. 4B shows the fresh air supply 8 in the completely open state, i.e. with the cover 83 omitted.

It should be noted that FIGS. 4A-4D show only the fresh air supply 8 and FIG. 4A additionally shows (in dashed lines) the outlet pipe 6, but not further components of the treatment container 10. Within the fresh air supply 8, the air supply channels 82 are open radially inwards and outwards. However, the openings of the air supply channels 82 pointing radially inwards and outwards are closed by the wall of the treatment container 10 and the outlet pipe 6 when the fresh air supply 8 is inserted into the treatment container 10 at the upper end, as shown for example in FIGS. 3A and 3B.

In the example shown in FIG. 4A, the cover 83 includes nine segments which together completely cover the air supply channels 82. However, the presence of nine segments is only one example. The number of segments can be arbitrarily selected. According to one example, the cover 83 of the fresh air supply 8 includes between four and 20 segments. The individual segments can each be of the same size, i.e. can each cover angular regions of the annular cover 83 of the same size, or can be of different sizes, i.e. can cover angular regions of different sizes.

The amount of fresh air which can enter the interior of the treatment container 10 via the fresh air supply 8 per unit of time during operation depends, among other things, on how many of the segments of the cover 83 are present, i.e. are fixed to the fresh air supply 8, and thus cover the air supply channels 82. The maximum amount of fresh air is supplied via the fresh air supply 8 per unit of time when all segments are omitted, i.e. when the fresh air supply 8 is completely open towards the top. No fresh air is supplied via the fresh air supply 8 when the cover 83 is completely closed.

When the air supply channels 82 are partially or completely open towards the top, fresh air can flow from above into the supply channels 82 and can flow from the supply channels 82 downwards in the vertical direction into the concentric channels 4a-4d. The fresh air flowing in via the air supply channels 82 serves to cool the cylindrical members 5a-5c.

According to one example, at least one of the segments of the cover 83, i.e. one, a plurality or all segments of the cover 83, is configured to be automatically opened and closed in order to be able to automatically control the fresh air supply in the treatment container 10. For this purpose, an automatically operable opening and closing apparatus configured to open or close the respective segment is provided on the at least one segment. This opening and closing apparatus can be any automatic opening and closing apparatus and includes, for example, a pneumatic cylinder, a linear motor or the like for opening and closing the respective segment.

According to an example, a plurality or all segments are configured to be automatically opened and closed and the number of opened segments is adjusted depending on the humidity inside the treatment container 10 in order, for example, to keep the humidity below a predetermined upper threshold. In this example, a further segment is always opened when the humidity reaches the predetermined threshold. Accordingly, in a further example, a further segment is always closed when the humidity decreases to a lower threshold in order to keep the humidity above the lower threshold.

To control the opening and closing apparatus(s), a control apparatus (not shown) can be provided which is configured to receive humidity information representing the humidity inside the treatment container 10 from a sensor (not shown) and to control the opening and closing apparatus depending on the humidity information in order to adjust the number of opened and closed segments of the cover 83.

The guide vanes 81 are oblique with respect to the vertical direction and are aligned in such a way that the air flowing in, when the air flows downwards towards the concentric channels 4a-4d, receives a tangential and vertical flow component which goes in the same direction as tangential flow components of the partial flows of the gas to be dehumidified flowing in the concentric channels 4a-4d.

The realization of the fresh air supply by a cover 83 having one or a plurality of segments configured to be opened and closed is only one example. Alternatively, the fresh air supply can be provided via at least one controlled or regulated valve which is disposed, for example, at the upper end of the treatment container 10 and which in the opened state enables a fresh air supply into the treatment container 10 and in the closed state prevents such a fresh air supply.

As mentioned above, the fresh air supply 8 is optional. That is, the treatment container 10 can also be closed at the upper end by a fixed cover. In this case, a cooling of the cylindrical members 5a-5c, as explained above, takes place, for example, by temporarily introducing no gas to be dehumidified, but fresh and cool air via the inlet 21 in the treatment container 10. An example of a fixed cover 84 from which the outlet pipe 6 protrudes is shown in a perspective view in FIG. 5. For better understanding, a part of the treatment container 10 adjoining the cover 83 at the bottom is also shown in FIG. 5.

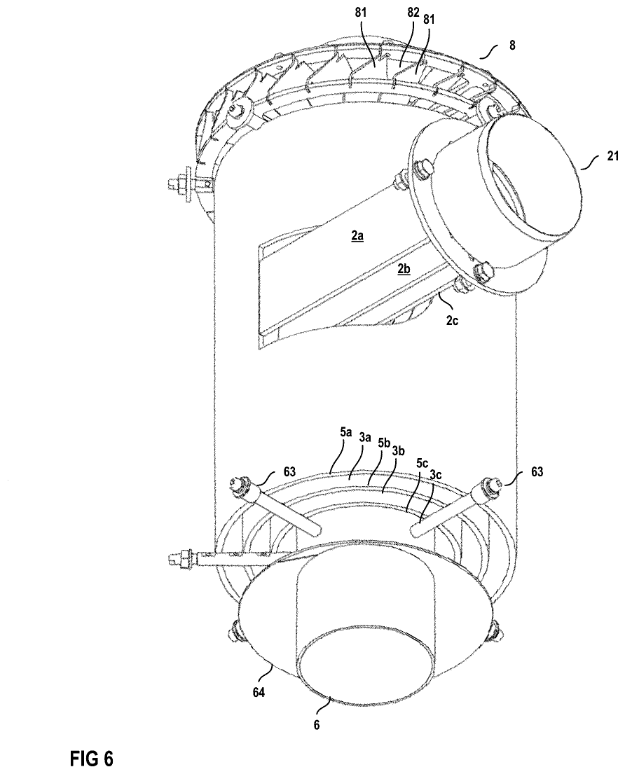

FIG. 6 shows a perspective view of the members disposed in the upper portion 13 inside the treatment container, wherein the treatment container 10 is not shown in FIG. 6. The cylindrical members 5a-5c and the webs 2a-2c inside the inlet pipe 2 (which is also not shown in FIG. 6) are shown in FIG. 6. The optional fresh air supply 8 with the guide vanes 81 and the inlet channels formed between the guide vanes 81 is shown in FIG. 6 (from a different direction than in FIGS. 4A-4D).

Optionally, as shown in FIG. 6, a conical upwardly tapering skirt 64 is arranged on the outlet pipe 6 below the cylindrical members 5a-5c and extends radially outwards from the outlet pipe 6. A diameter of this skirt 64 is, for example, between 50% and 75% of an inside diameter of the treatment container 10. This skirt 64 forces the gas flows, which move downwards from above out of the cylindrical channels 3a-3c, outwards in the radial direction. Thus, the gas flows move further downwards beyond the lower end of the outlet pipe 6 and a direction reversal only takes place spaced apart from the lower end of the outlet pipe 6. In addition, the skirt 64 causes liquid droplets to drop downwards at positions that are spaced apart from the outlet pipe 6 in the radial direction, so that the liquid droplets are not entrained into the outlet pipe 6 by the gas flow, which moves upwards from below into the outlet pipe 6.

Optionally, a separation fabric is arranged in the outlet pipe 6 which occupies the entire cross-section or parts of the cross-section of the outlet pipe 6 and through which at least a part of the gas flow in the outlet pipe 6 flows. The separation fabric serves for the final agglomeration and very fine separation of liquid droplets that may be entrained in the gas flow, and prevents the liquid droplets from leaving the treatment container 10 with the gas flow via the outlet pipe 6. The separation fabric includes, for example, woven/knitted threads (3D knitted fabric) made of a plastic, a metal, or even a natural fiber. The threads are selected, for example, such that the threads themselves absorb or temporarily bind no liquid or only little liquid.

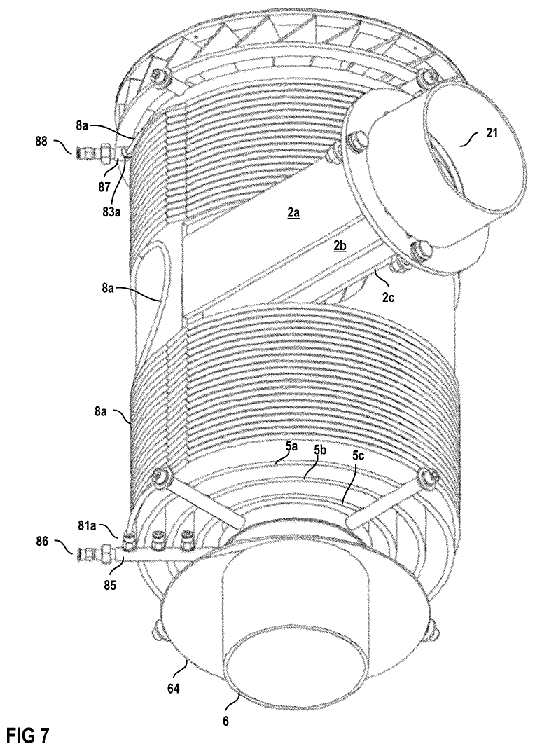

Another possibility for cooling the cylindrical members 5a-5c is to provide one or more coolant pipes on one or more of the members 5a-5c, where a coolant flows through the coolant pipe and thereby cools the respective member. This is explained below with reference to FIG. 7.

FIG. 7 schematically shows the members 5a-5c disposed inside the treatment container 10, where a coolant pipe 8a is disposed on one 5a of the members 5a-5c. Of course, corresponding coolant pipes can be disposed on all of the members 5a-5c. Merely for reasons of clarity, only one such coolant pipe 8a is shown in FIG. 5 on the outermost member 5a of the members 5a-5c.

The coolant pipe 8a has a first end 81a and a second end 83a, where one of the ends 81a, 83a serves as an inlet and another of the ends 81a, 83a serves as an outlet. Merely for explanation it is assumed that the first end 81a is the inlet and the second end 83a is the outlet of the coolant pipe 8a. The inlet 81a is connected to a supply pipe 85 via which coolant is supplied to the coolant pipe 8a. This supply pipe 85 has a connection 86 for connecting a corresponding coolant system thereto. The outlet 83a is connected to a discharge pipe 87 which has an outlet 88 which serves for connecting to the coolant system and via which the coolant is discharged from the coolant pipe 8a.

According to an example, the coolant supplied to the coolant pipe 8a via the supply pipe 81 and discharged from the coolant pipe 8a via the discharge pipe 83 circulates, where the coolant discharged via the outlet 84 is cooled before the coolant is again supplied via the inlet 82. This is explained in detail below.

The coolant pipe 8a includes a plurality of windings, for example, which are guided around the cylindrical member 5a in order to obtain a cooled surface area that is as large as possible. A liquid coolant, such as water, for example, or a gaseous coolant, such as air, for example, is suitable as the coolant flowing through the coolant pipe 8a. Depending on the coolant used, the coolant pipe 8a is made of a material that is impermeable to the respective coolant, such as metal or plastic, for example, or a material that is semipermeable to the respective coolant, such as a semipermeable plastic, for example. If a gaseous or liquid coolant is used, the coolant pipe 8a can be made of a material that is impermeable to the coolant, or alternatively of a material that is semipermeable to the coolant. The semipermeable material enables the coolant to partially enter the interior of the treatment container.

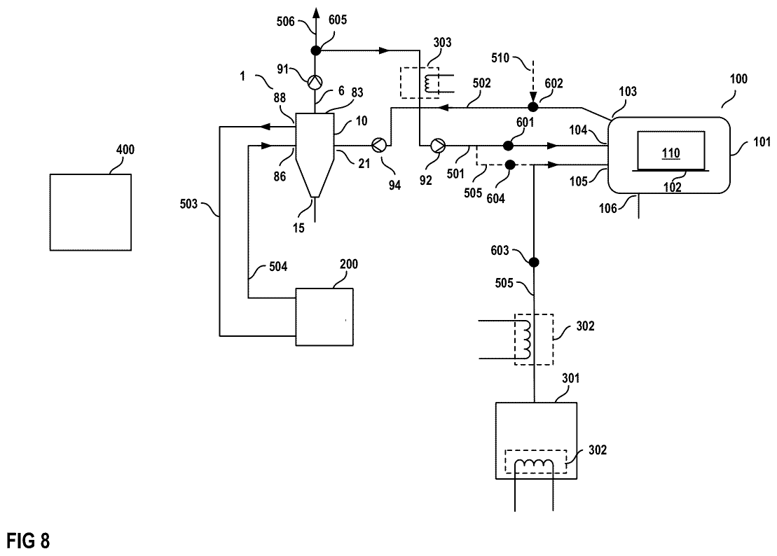

FIG. 8 schematically shows a system with the dehumidifying apparatus 1 according to one of the above-explained examples and a treatment apparatus 100. The treatment apparatus 100 is configured to clean workpieces using a cleaning agent and to dry the cleaned workpieces. The treatment apparatus 100, which is only schematically shown in FIG. 8, includes a treatment container 101 and a workpiece receptacle 102 disposed inside the treatment container 101 and configured to receive the workpieces to be treated by the treatment apparatus 100. The workpiece receptacle 102 is only schematically shown in FIG. 8.

One or more large workpieces or a plurality of small workpieces (bulk material) can be cleaned by the treatment apparatus 100, where bulk material is received, for example, by a workpiece basket supported by the workpiece receptacle 102. The workpiece to be treated by the treatment apparatus 100 or the workpieces to be treated by the treatment apparatus 100 are schematically shown in FIG. 8 and designated with the reference numeral 110.

The term “workpiece” is used in the following to represent one workpiece or a plurality of workpieces. Cleaning the at least one workpiece 110 by the treatment apparatus 100 includes, for example, cleaning the at least one workpiece 110 using a water-based cleaning agent. At least for drying the cleaned workpiece 110, a gas, such as air, for example, is used. This gas is hereinafter also referred to as process gas.

The treatment container 101 includes a first inlet 104, which is connected to the outlet pipe 6 of the dehumidifying apparatus 1 via a first connecting line 501 between the treatment tank 101 and the dehumidifying apparatus 1, so that the process gas is the dehumidified gas provided by the dehumidifying apparatus 1.

According to an example, the above-explained turbomachine 91, which serves to suck the dehumidified gas out of the dehumidifying apparatus 1 or to suck the moist gas into the dehumidifying apparatus 1 via the inlet 21, is arranged in the first connecting line 501 between the outlet pipe 6 of the dehumidifying apparatus 1 and the first inlet 104 of the treatment apparatus 100.

The treatment container 101 of the treatment apparatus 100 also includes a process gas outlet 103, which is connected to a second connecting line 502 between the treatment apparatus 100 and the dehumidifying apparatus 1. The second connecting line 502 is connected to the inlet 21 of the dehumidifying apparatus 1 at an end facing away from the process gas outlet 103 and serves to feed moist process gas from the treatment container 101 as gas to be dehumidified to the dehumidifying apparatus 1.

In the system shown in FIG. 8, the dehumidifying apparatus 1 and the treatment apparatus 100 form, together with the first and second connecting lines 501, 502, a closed circuit for the process gas, which is humidified in the treatment container 101 during the drying process and is subsequently dehumidified in the dehumidifying apparatus 1. In the example of FIG. 8, the turbomachine 91 serves to circulate the process gas. Optionally, a further turbomachine 92 may be present in the connecting line 501 between the dehumidifying apparatus 1 and the treatment container 101, where the further turbomachine 92 assists the conveyance of the process gas from the dehumidifying apparatus 1 to the treatment container 101 and through the treatment container 101.

As explained above, the dehumidifying apparatus 1 can include a cooling apparatus for cooling the cylindrical members 5a-5c. In this case, the input and output ports 86, 88 of the cooling apparatus can be connected to a cooling unit 200 via coolant pipes 503, 504. The cooling unit 200 is configured to cool coolant, which is supplied to the cooling unit 200 via the coolant pipe 503 from the outlet 84 of the cooling apparatus, and to provide cooled coolant. The cooling unit 200 is also configured to feed the cooled coolant to the inlet 86 of the cooling apparatus via the further coolant pipe 504. The coolant is, for example, water or another suitable liquid, or alternatively also a cooling gas.

As mentioned above, the treatment apparatus 100 also serves for cleaning the workpiece 110 using a cleaning agent. For this purpose, the cleaning container 101 includes a cleaning agent inlet 105 configured to receive a water-based cleaning agent from a cleaning agent reservoir 301 via a cleaning agent pipe 505. The cleaning agent supplied to the treatment apparatus 100 can be heated. For this purpose, a heater 302 (shown in dashed lines) is optionally present which is arranged in a cleaning agent pipe 505 between the cleaning agent reservoir 300 and the treatment apparatus 100 and/or in the cleaning agent reservoir 301 and which is configured to heat the cleaning agent. Contaminated cleaning agent can be discharged from the treatment container 101 via a cleaning agent outlet 106.

Optionally, the system has a heater 303 (shown in dashed lines) which is arranged in the first connecting line 501 between the dehumidifying apparatus 1 and the treatment apparatus 100 and which is configured to heat the process gas discharged from the treatment container 10 of the dehumidifying apparatus 1 before the process gas is supplied to the treatment apparatus 100.

In addition, the system can have various valves in connecting lines which serve, for example, to control the flow of process gas or cleaning agent. The valves are shown in FIG. 8 as nodes (black circles) in supply or connecting lines. Each of the valves has at least two valve positions. The valve positions of the valves are controlled by a control unit 400 which controls the process sequences in the system.

A first valve 601 is arranged, for example, in the first connecting line 501 in order to enable a flow of the process gas from the dehumidifying apparatus 1 to the treatment apparatus 100 in the opened state and to prevent a flow of the process gas from the dehumidifying apparatus to the treatment apparatus in the closed state. A second valve 602 is arranged, for example, in the second connecting line 502 in order to enable a flow of the process gas from the treatment apparatus 100 to the dehumidifying apparatus 1 in the opened state and to prevent a flow of the process gas from the treatment apparatus 100 to the dehumidifying apparatus 1 in the closed state.

According to one example, a third valve 603 is provided in the supply pipe 505 for the cleaning agent to the treatment apparatus 100, which third valve enables a flow of the cleaning agent from the cleaning agent reservoir 301 into the treatment container 101 of the treatment apparatus 100 in the opened state and prevents a flow of the cleaning agent into the treatment container 101 in the closed state.

Optionally, there is a connecting line 505 in the system from the first connecting line 501 to the cleaning agent inlet 105, where the connecting line 501 has a further valve 604. When the further valve 604 is open, process gas is fed via the connecting line 505 to the cleaning agent inlet 105 in order to feed process gas alternatively (when the first valve 601 is closed) or additionally (when the first valve 601 is open) to the treatment container 101 via the cleaning agent inlet 105. When the further valve 604 is open, the third valve 603 is closed, for example, in order to prevent process gas and cleaning agent from being simultaneously fed to the cleaning agent inlet 105.

Optionally, a further valve 605 is present in the first connecting line 501. The further valve 605 is connected to an exhaust air pipe 506 and is configured to conduct process gas in the first connecting line 501 either further in the first connecting line 501 in the direction of the process gas inlet 104 and/or 105 of the treatment apparatus 100 or to discharge process gas into the ambient air via the exhaust air pipe 506. The process gas is received from the outlet 6 of the dehumidifying apparatus 1, for example. Fresh air can be supplied to the treatment container 10 of the dehumidifying apparatus 1, for example, via the above-explained fresh air supply 83 (not shown in detail in FIG. 8).

Optionally, the system according to FIG. 8 includes a vacuum pump 94 disposed in the connecting line 502 between the process gas outlet 103 of the treatment container 101 and the inlet 21 of the dehumidifying apparatus 1. The vacuum pump 94 is configured to generate a vacuum in the treatment container 101 in order to thereby enable a vacuum drying process. Details of such a vacuum drying process are explained below.

In order to generate a vacuum in the treatment container 101 by the vacuum pump 94, the valve 601 in the connecting line 501 is closed and the optional valve 604 in the optional connecting line 505 is closed so that no air can flow into the treatment container 101 via the inlets 104, 105. The process gas discharged from the treatment container 101 by the vacuum pump 94 is dehumidified in the dehumidifying apparatus 1 and the dehumidified process gas is discharged to the environment via the turbomachine 91, the valve 605 and the exhaust air line 506. When the valve 601 and the optional valve 604 are open and when the valve 605 is in a valve position in which the dehumidified process gas is returned into the treatment container 101 in a circuit process, the vacuum pump 94 continues to operate in the circuit. However, the vacuum pump 94 is then not able to generate a vacuum since fresh process gas permanently flows into the treatment container 101 via the inlet 104 and optionally the inlet 105.

As explained above, cooling of the members of the dehumidifying apparatus 1 can be provided either via a fresh air supply at the upper end of the treatment container 10 of the dehumidifying apparatus 1 or can be provided by an intermittent process in which process gas to be dehumidified and dry cooling gas are alternately supplied to the dehumidifying apparatus 1 via the inlet 21. For such an intermittent process, the valve 602 in the connecting line 502 can be realized such that, apart from an opened state in which the valve 602 connects the process gas outlet 103 to the inlet 21 of the dehumidifying apparatus 1 and a closed state in which the valve 602 separates the process gas outlet 103 from the inlet 21 of the dehumidifying apparatus 1, it can assume a further state in which the valve 602 connects the inlet 21 of the dehumidifying apparatus 1 to a fresh air line 510. In this further state, the valve 602 supplies fresh air for cooling the members of the dehumidifying apparatus 1 to the inlet 21 of the dehumidifying apparatus 1 via the connecting line 502. The fresh air heated in the process is discharged to the environment via the outlet 6, the valve 605 and the exhaust air line 506.

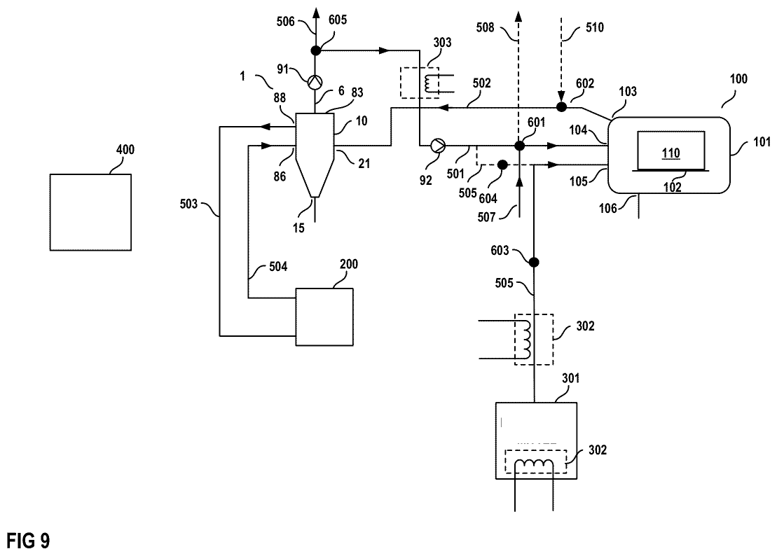

FIG. 9 shows a modification of the system shown in FIG. 8. Compared to the system according to FIG. 8, the system shown in FIG. 9 additionally includes a compressed air inlet 507 configured to receive compressed air. The compressed air is provided by a compressor (not shown), for example. The compressed air inlet 507 can be coupled to the process gas inlet 104 and/or the cleaning agent inlet 105 in order to introduce compressed air into the treatment container 101.

In the example shown in FIG. 9, the compressed air inlet 507 can be coupled to the process gas inlet 104. For this purpose, the process gas inlet 507 is connected to the first valve 601. In this example, the first valve 601 is configured such that the first valve 601 can have three different valve positions: (1) A first valve position in which the process gas inlet 104 is closed, i.e. is separated from the connecting line 501 to the turbomachine 92 and from the compressed air inlet 507. The first valve position corresponds to the closed state of the first valve 601 explained above. (2) A second valve position is possible in which the first valve 601 connects the process gas inlet 104 to the connecting line 501, but not to the compressed air inlet 507. (3) A third valve position is possible in which the first valve 601 connects the process gas inlet 104 to the compressed air inlet 507, but not to the connecting line 501.

In the system shown in FIG. 9, in addition to the dehumidifying process explained above with reference to FIG. 8, in which the gas to be dehumidified is circulated from the treatment container 101 to the dehumidifying apparatus 10 and back to the treatment container 101, a further dehumidifying process can be carried out. In the further dehumidifying process, compressed air is supplied via the compressed air inlet 507. In addition, the first valve 601 is in the third valve position so that supplied compressed air enters the treatment container 101 via the process gas inlet 104 and is humidified. The second valve 602 is open so that the humidified compressed air enters the dehumidifying apparatus 10 via the process gas outlet 101 and the connecting line 502, where the air is dehumidified. In this process, the dehumidified exhaust air discharged from the dehumidifying apparatus 10 enters the ambient air via the turbomachine 91, the further valve 605 and the exhaust air line 506. Thus, the further dehumidifying process is not a circuit process.

The compressed air is supplied via the compressed air inlet 507 intermittently (in spurts or pulses), for example, and can be referred to as a pulse blowing process, for example. The pulse blowing process is carried out, for example, directly after the cleaning process in the treatment container 101 has ended, i.e. when the air in the treatment container 101 is maximally humidified. The duration of the pulse blowing process is, for example, between a few seconds and one minute, such as between 10 and 30 seconds, for example. The circulation process explained above with reference to FIG. 8 lasts, for example, a few minutes, such as between 8 and 12 minutes, for example.

Optionally, the system according to FIG. 9 includes a further exhaust air line 508 connected to the first valve 601. In this example, the first valve 601 is configured to assume a fourth valve position in which the first valve 601 connects the connecting line 501 to the further exhaust air line 508 and separates the process gas inlet 104 from the connecting line 501 and the compressed air inlet 507. In this example, a further dehumidifying process or drying process is possible, which is hereinafter referred to as vacuum drying (process). In the vacuum drying process, the first valve 601 is in the fourth valve position which connects the exhaust air line 508 to the connecting line 501 and the turbomachine 92. The second valve 602 is open and the valve 605 at the outlet 6 of the dehumidifying apparatus 10 is in a valve position which connects the outlet 6 of the dehumidifying apparatus 10 to the turbomachine 92. In the vacuum drying process, at least one of the two turbomachines 91, 92 sucks air out of the treatment container 101 via the process gas outlet 103 and generates a vacuum in the treatment container 101. The cover 83 of the dehumidifying apparatus 10 is either closed or at most opened to such an extent that less air can flow in than is sucked out of the treatment container 101 by the at least one turbomachine 91, 92. This ensures that a vacuum is generated or maintained in the treatment container 101.

The vacuum drying process lasts, for example, a few minutes, such as between 3 and 5 minutes, for example, and is suitable for dehumidifying the air in the treatment container 101 down to a low residual moisture, such as a residual moisture of less than 1 percent, for example.

The system according to FIG. 9 can be modified to the effect that the compressed air inlet 507 is omitted, but the further exhaust air line 508 is maintained. Using such a system, the circuit process explained with reference to FIG. 8 and the vacuum drying process can be carried out.

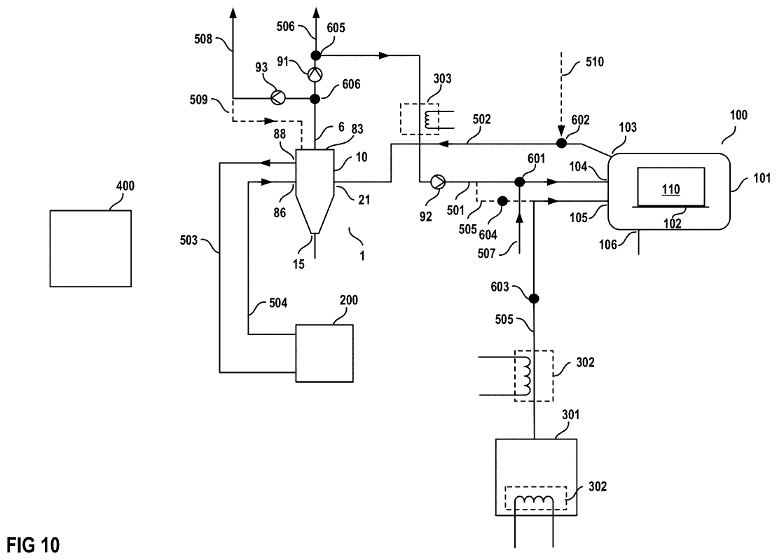

FIG. 10 shows a modification of the system shown in FIG. 9. In the system shown in FIG. 10, the further exhaust air line 508 is connected to the outlet pipe 6 of the dehumidifying apparatus 10 via a vacuum pump 93 and a further valve 606. The further valve 606 has at least two valve positions: (1) a first valve position in which the further valve 606 connects the outlet pipe 6 of the dehumidifying apparatus 10 to the further exhaust air line 508, and (2) a second valve position in which the further valve 606 connects the outlet pipe 6 of the dehumidifying apparatus 10 to the first turbomachine 91. The vacuum pump 93 is able to generate a lower pressure in the treatment container 101 than the two above-explained turbomachines 91, 92. In a vacuum drying process which can be carried out by means of the system according to FIG. 10, the first valve 601 separates the process gas inlet 104 from the connecting line 501 and the optional compressed air inlet 507 and the further valve 606 connects the outlet pipe 6 of the dehumidifying apparatus 10 to the vacuum pump 93 so that the vacuum pump 93 generates a vacuum in the treatment container 101 via the process gas outlet 103, the connecting line 502 and the dehumidifying apparatus 10.

Optionally, a portion of the process gas in the exhaust air line 508 is fed via a branch and a further connecting line 509 (shown in dashed lines) to the controlled or regulated fresh air supply 83 of the dehumidifying unit 10. Using such a process gas recirculation, the dehumidifying quality of the exhaust air can be efficiently increased.

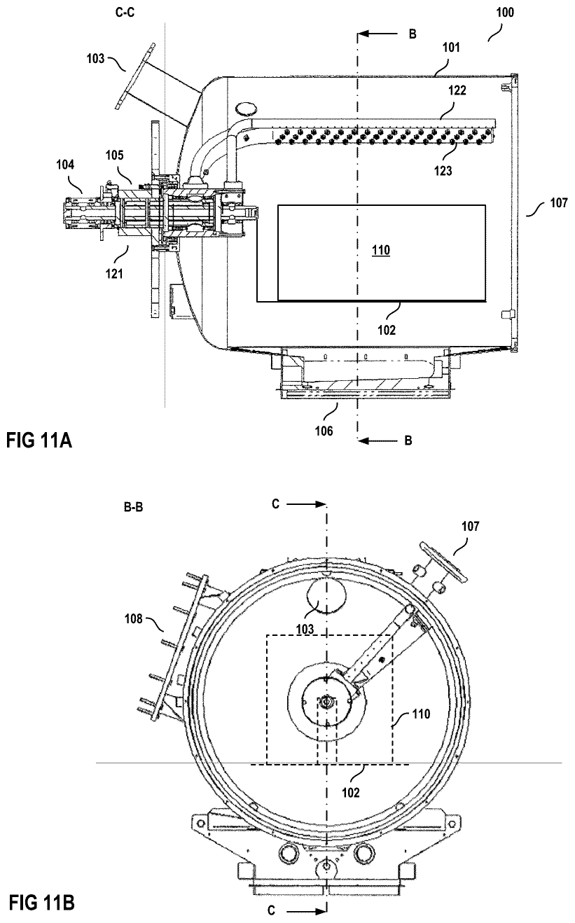

FIGS. 11A-11B show an example of the treatment apparatus 100 in further detail. FIG. 11A shows a cross-section of the treatment container 101 in a sectional plane C-C and FIG. 11B shows a cross-section of the treatment container 101 in a sectional plane B-B.

In the example shown in FIGS. 11A-11B, the treatment container 101 has a substantially cylindrical shape. At a first end face of the treatment container 101, a rotary feedthrough 121 is provided which is fixed to the treatment container 101 and which projects into the treatment container 101 in an opening provided at the first end face. Inside the treatment container 101, a first nozzle bar 122 and a second nozzle bar 123 are fixed to the rotary feedthrough 121. The first and the second nozzle bar 122, 123 are rotatably mounted using the rotary feedthrough 121 such that the two nozzle bars 122, 123 can rotate around the workpiece carrier 102 and the workpiece 110 held by the workpiece carrier 102.

The rotary feedthrough 121 includes a first channel which forms the process gas inlet 104 outside the treatment container 101, extends into the interior of the treatment container 101 within the rotary feedthrough 121 and opens into the first nozzle bar 122. The first nozzle bar 122 includes outlet nozzles configured to discharge process gas into the interior of the treatment container 101.

The rotary feedthrough 121 also includes a second channel which forms the cleaning agent inlet 105 outside the treatment container 101, extends into the interior of the treatment container 101 within the rotary feedthrough 121 and opens into the second nozzle bar 123. An inlet of the channel is located outside the drawing plane shown in FIG. 9A. The second nozzle bar 123 includes outlet nozzles configured to discharge the cleaning agent or the process gas into the interior of the treatment container 101, in particular onto the workpiece 110, during an operating phase. Such a rotary feedthrough 121 with nozzle bars 122, 123 disposed inside the treatment container 101 is generally known, so that no further explanations are required in this regard.

An example of a cleaning process which can be carried out with the treatment apparatus 100 shown in FIGS. 11A-11B includes cleaning the workpiece 110 using the cleaning agent which is discharged under pressure onto the workpiece 110 via the nozzles of the second nozzle bar 123. With the introduction of the cleaning agent via the nozzles of the second nozzle bar 123, a liquid bath of cleaning agent can be generated in the treatment container 101, where a liquid level of the liquid bath is set, for example, such that the workpiece 110, when the workpiece carrier 102 rotates in the treatment container 101, alternately dips into the liquid bath and passes a gas space formed above the liquid bath.

According to one example, a vacuum can be generated in the gas space above the liquid bath. The generation of the vacuum takes place via the process gas outlet 103 and one of the vacuum pumps or turbomachines connected to the process gas outlet 103 in the same manner in which a vacuum is generated in the treatment container in the above-explained vacuum drying process.

The process gas sucked out during the generation of the vacuum in the treatment container is dehumidified in the dehumidifying apparatus 1 in the same manner as in the vacuum drying process. The dehumidified process gas is subsequently discharged to the environment in the same manner as in the vacuum drying process.

To dry the workpiece 110, the discharge of cleaning agent via the second nozzle bar 123 is ended and the cleaning agent present in the treatment container 101 is discharged via the cleaning agent outlet 106. In addition, process gas, such as air, for example, is discharged under positive pressure onto the workpiece 110 via the nozzles of the first nozzle bar 122 and/or the second nozzle bar 123. The moist process gas produced during the drying process is sucked out (circulated) via the process gas outlet 103 during the drying process.

The treatment process can be observed via a viewing screen 108 in the treatment container 101.

What is claimed is:

1. An apparatus comprising:
a treatment container having an upper end, a lower end, and a feed opening disposed on a side of the treatment container;
a plurality of concentric channels disposed inside the treatment container, each of the concentric channels in communication with the feed opening and opening toward the lower end of the treatment container; and
an outlet pipe around which the plurality of concentric channels are disposed, the outlet pipe having an inlet at a lower end of the concentric channels, and extending out of the treatment container at the upper end.

2. The apparatus according to claim 1, wherein the concentric channels are formed by a sidewall of the treatment container, the outlet pipe, and a plurality of cylindrical members spaced apart from each other between the sidewall and the outlet pipe.

3. The apparatus according to claim 2, wherein a coolant pipe is disposed on at least one of the cylindrical members.

4. The apparatus according to claim 3, wherein the coolant pipe winds multiple times around the at least one cylindrical member.

5. The apparatus according to claim 1, wherein the feed opening is formed by an inlet pipe that opens into the treatment container on a side thereof.

6. The apparatus according to claim 5,
wherein a plurality of channels are formed in the inlet pipe, and
wherein each of the channels opens into a respective one of the concentric channels.

7. The apparatus according to claim 1,
wherein the treatment container has a cylindrical upper portion and a lower portion tapering conically towards the lower end, and
wherein the concentric channels are arranged in the upper portion.

8. The apparatus according to claim 1,
wherein a ratio between a height of the upper portion and a height of the lower portion is between 2:1 and 1:2.

9. The apparatus according to claim 1,
wherein the treatment container has an outlet at the lower end.

10. The apparatus according to claim 1,
wherein the treatment container is closed at the upper end around the outlet pipe by a fixed cover.

11. The apparatus according to claim 1,
wherein the apparatus includes a fresh air supply in the upper portion, the fresh air supply being arranged around the outlet pipe and having fresh air inlets directed upwards.

12. The apparatus according to claim 11,
wherein the fresh air inlets are formed by guide vanes arranged adjacent to each other, extending radially outwards from the outlet pipe and arranged obliquely with respect to a vertical direction.

13. The apparatus according to claim 11,
wherein the fresh air supply includes a cover having a plurality of segments configured to be opened and closed independently of each other, or a valve.

14. The apparatus according to claim 13,
wherein at least one of the segments or the valve is configured to be automatically opened and closed.

15. The apparatus according to claim 1,
wherein a separation fabric is arranged in the outlet pipe.

16. The apparatus according to claim 2,
wherein the cylindrical members and the outlet pipe are fixed to the treatment container via webs.

17. A system comprising:
a treatment container having an upper end, a lower end, and a feed opening disposed on a side of the treatment container;
a plurality of concentric channels disposed inside the treatment container, each of the concentric channels in communication with the feed opening, and opening toward the lower end of the treatment container;
an outlet pipe around which the plurality of concentric channels are disposed, the outlet pipe having an inlet at a lower end of the concentric channels, and extending out of the treatment container at the upper end; and
a treatment apparatus configured to clean and/or dry a workpiece,
wherein the treatment apparatus includes a treatment container having a process gas inlet and a process gas outlet, and
wherein the process gas inlet is connected to the outlet pipe of the apparatus and the process gas outlet is connected to the feed opening of the apparatus.

18. The system according to claim 17, further comprising:
a heater arranged on a connecting line between the outlet pipe of the apparatus and the process gas inlet of the treatment apparatus which is configured to heat a gas flowing through the connecting line.

19. The system according to claim 17,
wherein the apparatus and the treatment apparatus form a closed system together with connecting lines between the apparatus and the treatment apparatus.

20. The system according to claim 17, further comprising:
a cooling unit connected to coolant ports of the apparatus.

21. A method comprising:
dehumidifying a gas using an apparatus having a treatment container having an upper end, a lower end, and an inlet disposed on a side of the treatment container, a plurality of concentric channels disposed inside the treatment container, each in communication with the inlet, and opening toward the lower end of the treatment container, and an outlet pipe around which the plurality of concentric channels are disposed, the outlet pipe having an inlet at a lower end of the concentric channels, and extending out of the treatment container at the upper end;
supplying the gas into the treatment container via the inlet;
passing the gas through the concentric channels in the treatment container; and
discharging the dehumidified gas from the treatment container via the outlet pipe.

22. The method according to claim 21, further comprising:
supplying the dehumidified gas provided via the outlet pipe of the apparatus to a process gas inlet of a treatment apparatus via a connecting line.

23. The method according to claim 22, wherein the gas to be dehumidified is provided at a process gas outlet of the treatment apparatus and is supplied to the inlet of the apparatus via a connecting line.

24. The method according to claim 23, wherein the apparatus and the treatment apparatus form a closed system together with the connecting lines.

25. The method according to claim 23, the method further comprising:
generating a negative pressure in a treatment container of the treatment apparatus using a continuous-flow machine or a vacuum pump coupled to the process gas outlet; and
discharging exhaust air of the apparatus to the environment.
